(19) United States
(12) Patent Application Publication
(10) Pub. No.: US 2005/0162659 A1
(43) Pub. Date: Jul. 28, 2005

(54) Optical interferometer

(75) Inventors: Neville John Freeman, Tarporley (GB); Graham Cross, Stockton-On-Tees (GB); Gerard Anthony Ronan, Salford (GB); Marcus Swann, Durham (GB)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Farfield Sensors Limited, Wythenshawe (GB)

(21) Appl. No.: 10/507,435

(22) PCT Filed: Mar. 13, 2003
(86) PCT No.: PCT/GB03/01059

(30) Foreign Application Priority Data
Mar. 14, 2002 (GB) 0206008.5

(51) Int. Cl. G01B 9/02

(52) U.S. Cl. 356/477

(57) ABSTRACT

The present invention relates to an integrated optical waveguide interferometer including a sensing waveguide with a path of interaction (with the localised environment) having different optical lengths, and to a method for determining the absolute status thereof after the introduction into the localised environment of (or changes in) a stimulus of interest and to a method for determining the absolute calibration status thereof before the introduction into the localised environment of (or changes in) a stimulus of interest.

The present invention relates to an integrated optical waveguide interferometer including a sensing waveguide with a path of interaction (with the localised environment) of variable optical length, and to a process for determining the absolute status thereof after the introduction into the localised environment of (or changes in) a stimulus of interest and to a method for determining the absolute calibration status thereof before the introduction into the localised environment of (or changes in) a stimulus of interest.

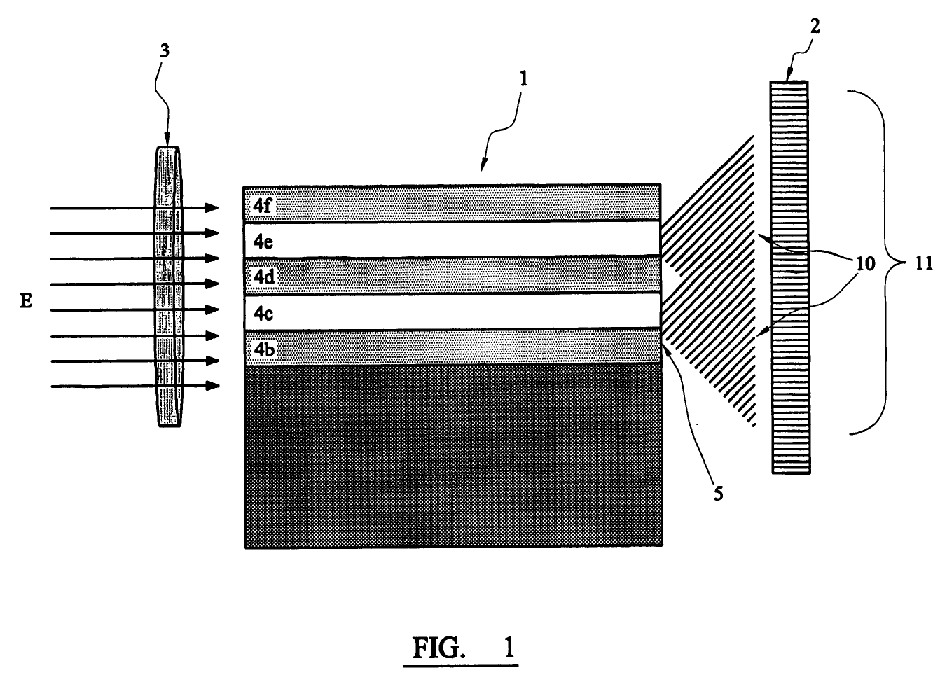

Optical interferometry is a well-established technique in the field of sensing. It is intrinsic to optical interferometers that the response is cyclical and provides identical information every integer multiple of 2π radians in phase difference. In order to track differences in optical path length over ranges greater than 2π radians, a fringe counting method is generally required. However in the case of integrated optical interferometers, a large stimulus applied rapidly to the sensing waveguide may cause the loss of information through miscounting. This phenomenon is known as aliasing and is described hereinafter in detail with reference to FIG. 1.

In order to address aliasing, it is known to exploit two or more wavelengths to provide a difference signal that acts as a slowly varying phase position marker. In the case of optical interferometers for chemical and biological sensing, refractive index dispersion in the chemical or biological materials may complicate such an analysis.

It will be appreciated that over its lifetime, an optical interferometer will be exposed continuously to a changing localised environment and its absolute status will vary accordingly. For example, the level of moisture absorbed into the sensing waveguide will vary according to atmospheric conditions. In practice, this means that the optical interferometer will need to be calibrated on each occasion before it is used (typically with a calibrant gas). This allows measured changes in effective refractive index to be related exclusively to the introduction of or changes in a stimulus of interest. The need to calibrate the instrument prior to each use is a great inconvenience to the user and the use of standard material calibrants is restrictive.

If the history of the phase differences are not known or are lost during an interruption in monitoring the optical interferometer, the user cannot determine its absolute status in response to an analyte. Starting or resuming operation may lead to significant errors since signal loss (aliasing) may have occurred. Typically this means that once an optical interferometer is calibrated, it is not possible to switch it off without the calibration being lost.

WO-A-01/36947 (Farfield Sensors Limited) discloses the use of thermal or wavelength biassing to make absolute measurements of an optical interferometer and to address aliasing. This requires rather sophisticated ancillary components to be incorporated into the sensor assembly.

The present invention seeks to greatly reduce the risk of aliasing and eliminate the need for standard calibration prior to use by exploiting an optical interferometer having a sensing waveguide with a built-in reference system. More particularly, the present invention relates to an integrated optical waveguide interferometer having on its sensing waveguide a well characterised, variable optical length path of interaction.

Thus viewed from one aspect the present invention provides an integrated optical waveguide interferometer capable of detecting the amount of (eg concentration of) or changes in a stimulus of interest comprising:
a sensing waveguide capable of exhibiting a measurable response to a change in a localised environment caused by the introduction of or changes in the stimulus of interest, said sensing waveguide having a path of interaction of variable optical length.

The integrated optical waveguide interferometer of the invention allows the user to determine its absolute status (regardless of the arbitrary phase position) before or after the introduction of a stimulus of interest. It is also a straightforward matter to verify that the integrated optical waveguide interferometer of the invention remains in its previously determined state after suspension of operation (eg a power failure) has prevented continuous monitoring of the phase shift. This substantially eliminates the risk of the output of the integrated optical waveguide interferometer being subjected to aliasing.

The integrated optical waveguide interferometer may be generally of the type disclosed in WO-A-98/22807 or WO-A-01/36945.

In a preferred embodiment, the integrated optical waveguide interferometer further includes:
one or more sensing layers capable of inducing in the sensing waveguide a measurable response to a change in the localised environment caused by the introduction of or changes in a stimulus of interest.

In this embodiment, the integrated optical waveguide interferometer is advantageously adapted to optimise the evanescent component so as to induce in the sensing waveguide a measurable response. The integrated optical waveguide interferometer may comprise a plurality of separate sensing layers to enable changes at different localised environments to be detected.

The (or each) sensing layer may be or include the stimulus of interest.

In a preferred integrated optical waveguide interferometer of the invention, the sensing layer comprises an absorbent material (eg a polymeric material such as polymethylmethacrylate, polysiloxane, poly-4-vinylpyridine) or a bioactive material (eg containing antibodies, enzymes, DNA fragments, functional proteins or whole cells). The absorbent material may be capable of absorbing a gas, a liquid or a vapour analyte containing a chemical stimulus of interest. The bioactive material may be appropriate for liquid or gas phase biosensing. For example, the sensing layer may comprise a porous silicon material optionally biofunctionalised with antibodies, enzymes, DNA fragments, functional proteins or whole cells. In an integrated optical waveguide interferometer for use in biological or chemical sensing, the interaction of the stimulus of interest with the sensing layer may be a binding interaction or absorbance or any other interaction.

To optimise its performance, the integrated optical waveguide interferometer may further comprise an inactive waveguide in which the sensing layer is substantially incapable of inducing a measurable response to a change in the localised environment caused by the introduction of or changes in the stimulus of interest. The inactive waveguide is capable of acting as a reference layer. It is preferred that the sensing waveguide and inactive waveguide have identical properties with the exception of the measurable response to the change in the localised environment caused by the introduction of or changes in the stimulus of interest.

In a preferred integrated optical waveguide interferometer of the invention, the sensing waveguide (and/or inactive waveguide) comprises silicon nitride or (preferably) silicon oxynitride.

Preferably the sensing waveguide and any additional waveguide (such as a reference waveguide) is a planar waveguide (ie a waveguide which permits light propagation in any arbitrary direction within the plane), particularly preferably a slab waveguide.

In a preferred embodiment, the variation in optical length of the path of interaction is sufficient to ensure a variation in phase change caused by the introduction of or changes in a stimulus of interest of <2π.

By way of example, the path of interaction may be stepped. Preferably the path of interaction is of dual optical length. Particularly preferably the difference in dual optical length is sufficient to ensure a difference in phase change caused by the introduction of or changes in a stimulus of interest of <2π.

The optical length of the path of interaction (L′) is related to the geometrical length of the path of interaction (L) by the relationship:
L′=λL/n
(where λ is the free space wavelength of electromagnetic radiation and n is the refractive index of the path of interaction).

Thus the variable optical length of the path of interaction may be provided by a variation in its geometrical length. Preferably the variation in geometrical length is sufficient to ensure a variation in phase change caused by the introduction of or changes in a stimulus of interest of <2π.

For example, the geometrical length of the path of interaction may be stepped. Preferably the path of interaction is of dual geometrical length. Particularly preferably the difference in dual geometrical length is sufficient to ensure a difference in phase change caused by the introduction of or changes in a stimulus of interest of <2π.

The variation in the geometrical length of the path of interaction may be continuous. For example, the path of interaction may have a gradient.

The variable optical length of the path of interaction may be provided by a variation in its refractive index. The refractive index may be varied intrinsically or dimensionally.

The refractive index may be varied intrinsically by varying the composition of the material of the sensing waveguide. For example, the sensing waveguide may be composed of two or more discrete portions of material of differing (and well characterised) composition. Preferably the sensing waveguide is of dual composition.

Preferably the refractive index is varied dimensionally (which can be advantageously achieved very accurately through know fabrication techniques). For example, the refractive index may be varied dimensionally by varying the thickness of the sensing waveguide. Preferably the sensing waveguide is of dual thickness.

In a preferred embodiment, the integrated optical waveguide interferometer further comprises a capping layer adapted to define the path of interaction of variable optical length. The capping layer is typically in contact with the surface of the sensing waveguide.

The capping layer may incorporate a window which bounds the localised environment (eg above the part of the sensing waveguide with which the capping layer is in contact). For example, the window may bound a sensing layer such as an absorbent material or a bioactive material (described in greater detail above). The shape of the window may be tailored to precisely define the variation in the optical length of the path of interaction.

By incorporating a window, the capping layer defines a path of interaction of (at least) dual optical length in which a first part of the modal field interacts with the medium in the window and a second part of the modal field interacts with the medium of the capping layer.

The composition (and therefore the refractive index) of a capping layer may be precisely determined using standard material deposition methods familiar in semiconductor processing (for example, silicon dioxide deposition using PECVD). Photolithography may be used in defining the window and typically has a resolution of less than 1 micron. The variation in path length can thus be controlled to this level.

Suitable capping layers are described in copending UK patent application no. 0203581.4 filed on Feb. 15, 2002 by Farfield Sensors Limited. The capping layer typically has a thickness of 10 microns or less, preferably 5 microns or less and may be composed of silicon dioxide.

Preferably the integrated optical waveguide interferometer constitutes a multi-layered structure (eg a laminated waveguide structure). In a preferred embodiment, each of the plurality of layers in the multi-layered structure are built onto a substrate (eg of silicon) through known processes such as PECVD, LPCVD, etc. Such processes are highly repeatable and lead to accurate manufacture. Intermediate transparent layers may be added (eg silicon dioxide) if desired. Typically the multilayered structure is of thickness in the range 0.2-10 microns. A layered structure advantageously permits layers to be in close proximity (eg a sensing waveguide and an inactive (reference) waveguide may be in close proximity to one another so as to minimise the deleterious effects of temperature and other environmental factors). Preferably the integrated optical waveguide interferometer comprises a stack of transparent dielectric layers wherein layers are placed in close proximity. Preferably each layer is fabricated to allow equal amounts of electromagnetic radiation to propagate by simultaneous excitation of the guided modes in the structure. Particularly preferably, the amount of electromagnetic radiation in the sensing waveguide/inactive waveguide is equal.

Electromagnetic radiation generated from a conventional source may be propagated into the integrated optical waveguide interferometer in a number of ways. In a preferred embodiment, radiation is simply input via an end face of the integrated optical waveguide interferometer (this is sometimes described as “an end firing procedure”). Preferably the electromagnetic radiation source provides incident electromagnetic radiation having a wavelength falling within the optical range. Propagating means may be employed for substantially simultaneously propagating incident electromagnetic radiation into a plurality of waveguides. For example, one or more coupling gratings or mirrors may be used. A tapered end coupler rather than a coupling grating or mirror may be used to propagate light into the lowermost waveguide.

The incident electromagnetic radiation may be oriented (eg plane polarised) as desired using an appropriate polarising means. The incident electromagnetic radiation may be focussed if desired using a lens or similar micro-focussing means.

The integrated optical waveguide interferometer may further comprise: means for intimately exposing at least a part of the sensing waveguide (or at least a part of the (or each) sensing layer) to the localised environment (eg as described in WO-A-01/36945). For example, the means for intimately exposing at least a part of the sensing waveguide (or at least a part of the (or each) sensing layer) to the localised environment may be a part of a microstructure positionable on the surface of and in intimate contact with the sensing waveguide. The microstructure may comprise means for intimately exposing at least a part of the sensing waveguide (or at least a part of the (or each) sensing layer) to the localised environment in the form of one or more microchannels and/or microchambers. For example, an analyte containing chemical stimuli may be fed through microchannels or chemical reactions may take place in an analyte located in a microchamber. An analyte containing chemical stimuli may be fed into the microchannels by capillary action or positively fed by an urging means. The means for intimately exposing at least a part of the sensing waveguide (or at least a part of the (or each) sensing layer) to the localised environment may be integrated onto the sensing waveguide or may be included in a cladding layer. For example, microchannels and/or microchambers may be etched into the cladding layer.

The means for intimately exposing at least a part of the sensing waveguide (or at least a part of the (or each) sensing layer) to the localised environment may be adapted to induce chemical or biological changes in a static analyte containing a chemical or biological stimulus of interest. In this sense, the system may be considered to be dynamic. Chemical or biological changes (eg reactions) may be induced in any conventional manner such as by heat or radiation.

As a consequence of the introduction of or changes in a physical, biological and/or chemical stimulus of interest in the localised environment (ie a change in the refractive index of material in the localised environment), changes in the transmission of electromagnetic radiation down the sensing waveguide occur which may be measured (ie a measurable response). Due to the variation in optical length of the path of interaction, the measurable response varies. Thus by comparing the varying measurable response the optical interferometer of the invention makes available a slowly varying phase position marker over many cycles of phase change and by dispensing with the need for standard calibration allows measurements of the absolute status of the integrated optical waveguide interferometer before or after the introduction of a stimulus of interest.

Viewed from a further aspect the present invention provides a process for determining the absolute status of an integrated optical waveguide interferometer, said process comprising:
(A) providing an integrated optical waveguide interferometer as hereinbefore defined;
(B) irradiating the integrated optical waveguide interferometer with electromagnetic radiation;
(C) introducing to the localised environment a stimulus of interest;
(D) measuring the variation in phase shift of the modal field interacting with the path of interaction; and
(E) calculating from the variation in phase shift the absolute status of the integrated optical waveguide interferometer.

Preferably the variation in phase shift caused by the introduction of or changes in a stimulus of interest is <2π.

In a preferred embodiment, the process of the invention comprises:
(A1) providing an integrated optical waveguide interferometer as hereinbefore defined, wherein the path of interaction is of dual optical length;
(B) irradiating the integrated optical waveguide interferometer with electromagnetic radiation;
(C) introducing to the localised environment a stimulus of interest;
(D1) measuring the difference in phase shift of the first and second parts of the modal field interacting with the path of interaction of dual optical length respectively; and
(E1) calculating from the difference in phase shift the absolute status of the integrated optical waveguide interferometer.

Preferably the difference in phase shift caused by the introduction of or changes in a stimulus of interest is <2π.

Preferably the process further comprises:
(F) relating the absolute status to the amount (eg concentration) of or changes in the chemical stimulus of interest. Methods for performing this calculation will be familiar to those skilled in the art.

Viewed from a yet further aspect the present invention provides a method for determining the absolute calibration status of an integrated optical waveguide interferometer, said process comprising:
(A) providing an integrated optical waveguide interferometer as hereinbefore defined;
(B) irradiating the integrated optical waveguide interferometer with electromagnetic radiation;
(C) measuring the variation in phase position of the modal field interacting with the path of interaction; and
(D) calculating from the variation in phase position the absolute calibration status of the integrated optical waveguide interferometer.

In a preferred embodiment, the method of the invention comprises:
(A1) providing an integrated optical waveguide interferometer as hereinbefore defined, wherein the path of interaction is of dual optical length;
(B) irradiating the integrated optical waveguide interferometer with electromagnetic radiation;
(C1) measuring the difference in phase position of the first and second parts of the modal field interacting with the path of interaction of dual optical length respectively; and
(D1) calculating from the difference in phase position the absolute status of the integrated optical waveguide interferomete

In a preferred embodiment, steps (A) to (C) are performed at start-up (eg automatically).

An interference pattern may be generated when the electromagnetic radiation from the integrated optical waveguide interferometer is coupled into free space and the pattern may be recorded in a conventional manner (see for example WO-A-98/22807). A measurable response of the sensing waveguide to a change in the localised environment manifests itself as movement of the fringes in the interference pattern. The phase shift of the radiation in the sensing waveguide may be straightforwardly calculated from the movement in the fringes.

Movement in the interference fringes may be measured either using a single detector which measures changes in the electromagnetic radiation intensity or a plurality of such detectors which monitor the change occurring in a number of fringes or the entire interference pattern. The one or more detectors may comprise one or more photodetectors. Where more than one photodetector is used this may be arranged in an array.

Preferably the integrated optical waveguide interferometer is adapted to determine its absolute calibration status at start-up. Particularly preferably the integrated optical waveguide interferometer is adapted to determine its absolute calibration status automatically at start-up.

The present invention will now be described in a non-limitative sense with reference to the accompanying Figures in which:

FIG. 1 illustrates in side view an integrated optical waveguide interferometer of the prior art;

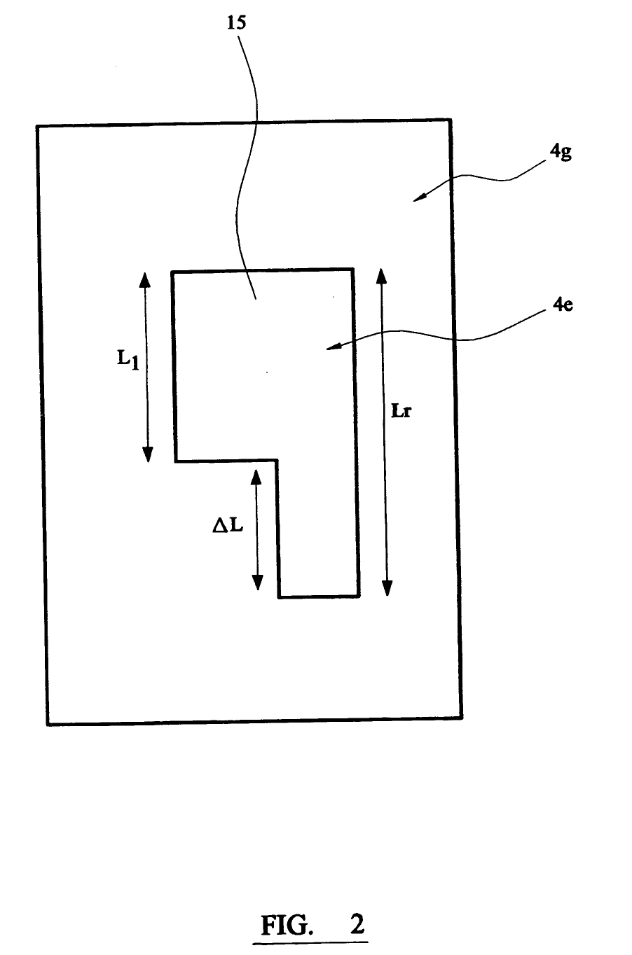

FIG. 2 illustrates in exposed plan view the an embodiment of the integrated optical waveguide interferometer of the invention;

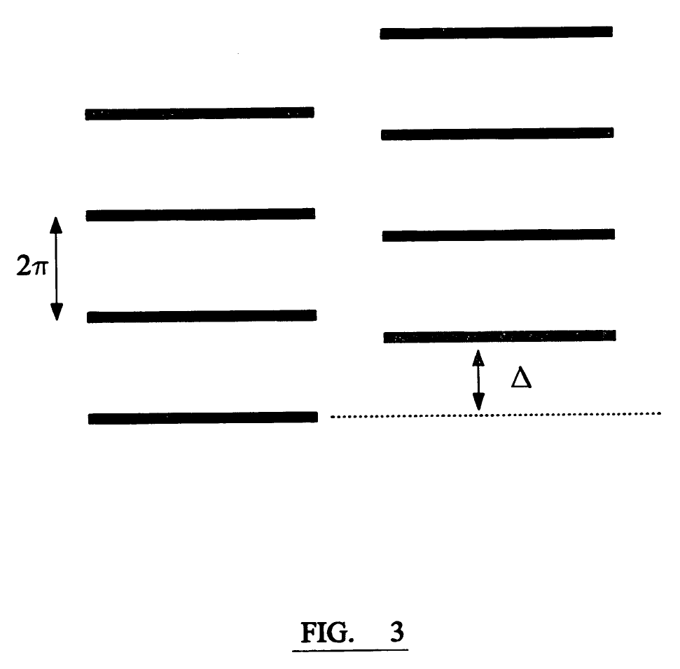

FIG. 3 illustrates the interference pattern produced from the left and right hand modal fields of the embodiment of FIG. 2;

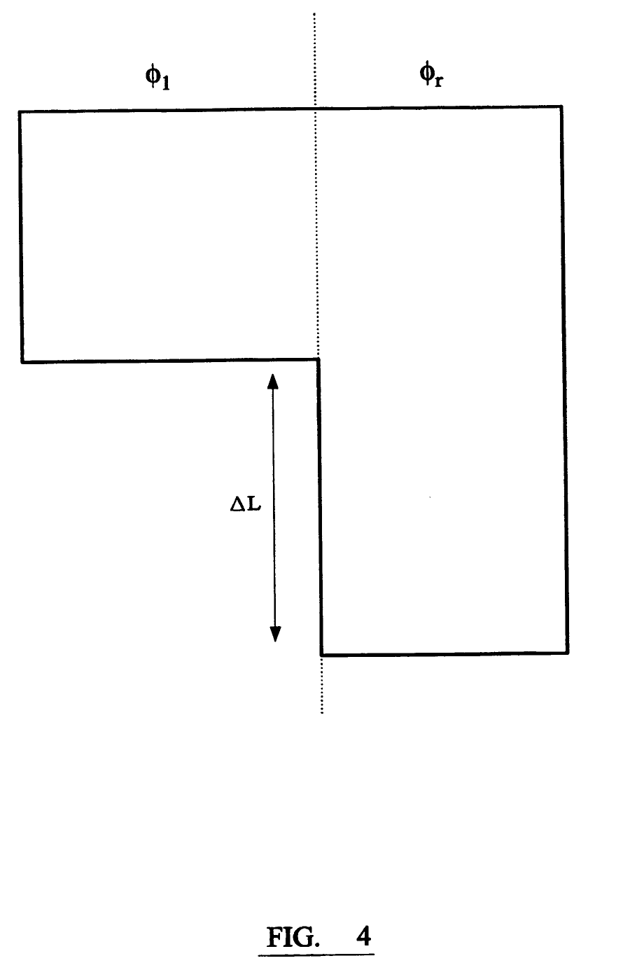

FIG. 4 illustrates the two parallel modal fields φₗ and φᵣ and their difference in path length of interaction;

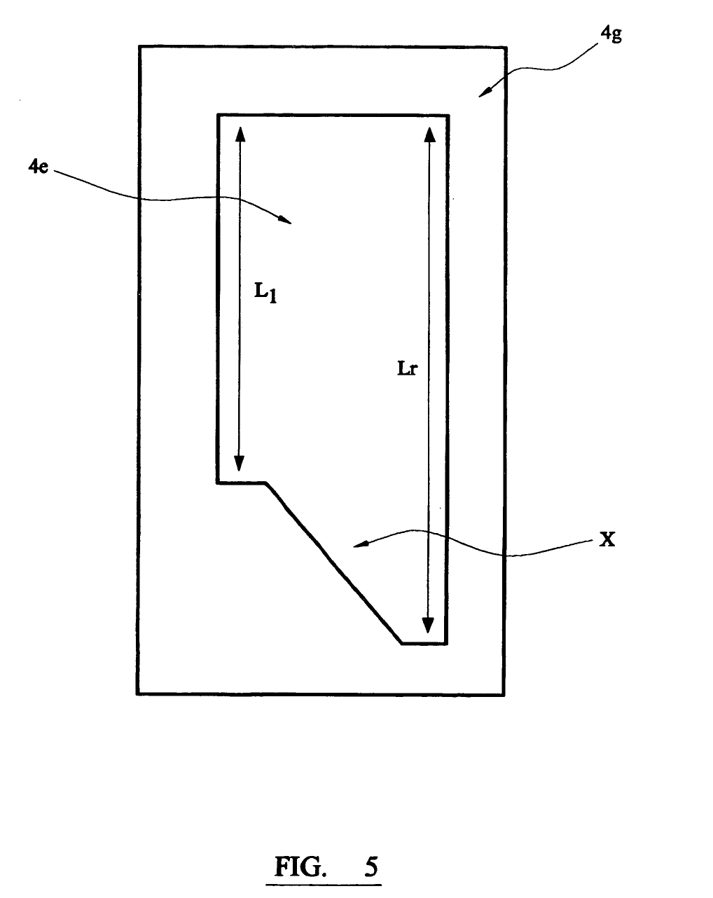

FIG. 5 illustrates in exposed plan view an embodiment of the integrated optical waveguide interferometer of the invention;

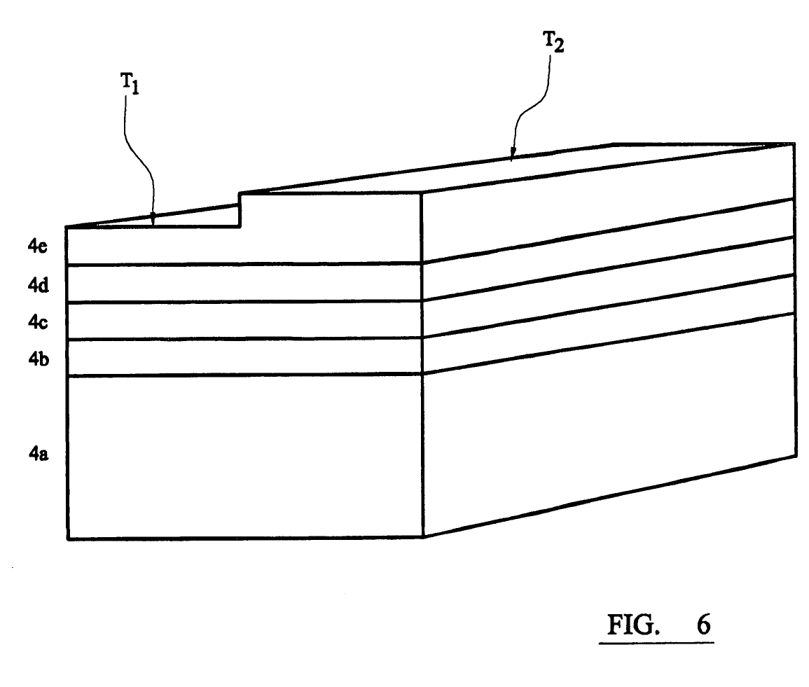

FIG. 6 illustrates an embodiment of the integrated optical waveguide interferometer of the invention; and

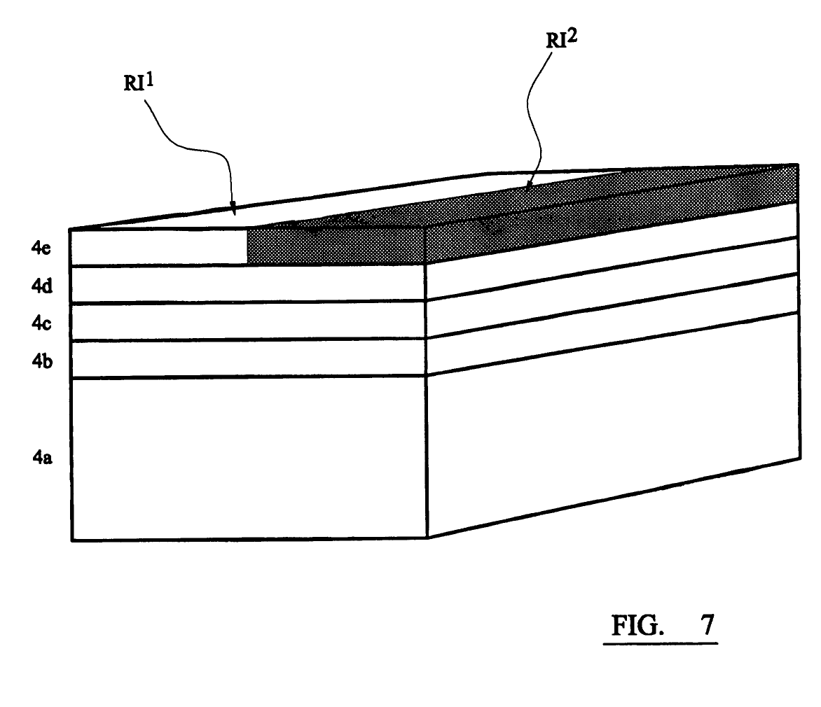

FIG. 7 illustrates an embodiment of the integrated optical waveguide interferometer of the invention.

FIG. 1 illustrates in side view an integrated optical waveguide interferometer of the prior art designated generally by reference numeral 1. The integrated optical waveguide interferometer 1 is of the type described in WO-A-98/22807 which in this embodiment comprises a silicon substrate layer 4a, silicon dioxide layers 4b and 4d, silicon oxynitride layers 4c and 4e and an absorbent sensing layer 4f. The silicon oxynitride layer 4c acts as the reference waveguide and the silicon oxynitride layer 4e acts as the sensing waveguide so that the integrated optical waveguide interferometer 1 is deployed in evanescent mode. The assembly further comprises a photodetector 2 for detecting fringes 10 of an interference pattern 11 in the far field, a focussing lens 3 and a source (not shown) of electromagnetic radiation E.

The silicon oxynitride layer 4e (the sensing waveguide) acts through its evanescent field to provide a transduction mechanism for changes in the optogeometrical properties of the absorbent sensing layer 4f. The propagation constant of the sensing waveguide mode (β) is altered as the optogeometrical properties of the absorbent sensing layer 4f change and when the far field output of the sensing waveguide mode is recombined with that of the reference waveguide 4c, the intensity distribution of the interference pattern 11 shifts.

The observed phase shift (Δφ) is related to the shift in relative phase position between the interfering modal fields of the sensing waveguide 4e and reference waveguide 4c at the output face 5. Since the modal field of the reference waveguide 4c is essentially unaffected by changes in the optogeometrical properties of the absorbent sensing layer 4f, the observed phase shift is almost exclusively due to changes in the propagation constant of the sensing waveguide mode. Over a length (L) of a path of interaction (the length over which the evanescent field can act as a transducer) the observed phase shift is given by:
Δφ=ΔβL
(where Δβ is the change in the propagation constant β per unit length of interaction). The interference pattern 11 produced in the far field is reproduced identically when:
Δφ=n2π
(where n is an integer).

Thus if a method of ‘fringe counting’ (ie the counting of n) is not employed or the method cannot record rapid and large changes in phase quickly enough, it will be impossible to unambiguously determine the value of Δφ.

Absolute Measurements and Prevention of Aliasing

FIG. 2 illustrates in exposed plan view an embodiment of the integrated optical waveguide interferometer of the invention. It is largely the same as that described above with reference to FIG. 1 but the absorbent sensing layer 4f has been replaced by a capping layer 4g of known refractive index into which a window 15 of precisely defined dimensions has been introduced by selective removal of the layer thereby exposing the surface of the sensing waveguide 4e. The window 15 provides a path of interaction where the evanescent field of the sensing waveguide mode can interact with the medium within the window. The path of interaction is of dual length L₁ and L₂ differing in path length by ΔL.

The phase changes Δφₗ and Δφᵣ experienced by the left and right parts of the modal field carried in the path of interaction of dual length Lₗ and Lᵣ are different since the path length differs. The difference Δ between the phase changes is a much slower function of Δβ since it is determined by the difference in path length:
Δ=Δφₗ−Δφᵣ=ΔβΔL=Δβ(Lₗ−Lᵣ)

If the condition Δ<2π is achieved by designing a suitably small difference in path length ΔL, the interference pattern produced from the left and right parts of the modal field will remain within one cycle of repetition (when compared together) through the many cycles of phase change experienced individually by the left and right parts of the modal field (see FIG. 3).

By way of example, a stimulus of interest typically causes a change in the propagation constant (Δβ) of 11.283×10³m⁻¹ (such a change occurs when water is introduced to replace air as the medium above the surface of the sensing waveguide). The maximum difference in path length required is then given by ΔL=2π/Δβ=0.557 mm.

Aliasing is prevented since the relative phase positions of the parallel parts of the modal field carried in the path of interaction of dual length can be determined before and after the stimulus of interest is introduced. There is no need to monitor continuously the phase position of each individual component during the application of the stimulus of interest. Obtaining Δ in this way and knowing ΔL leads directly to the desired Δβ.

Calibration

In place of the absorbent sensing layer 4f in FIG. 1, it is possible to incorporate a capping layer (or spacer) in which a window of precisely defined dimensions serves to expose the silicon oxynitride layer 4e (the sensing waveguide) to a stimulus of interest. For example, a capping layer 4g may be used to define a dual path of interaction as described above with reference to FIG. 2. The composition and therefore the refractive index of the capping layer 4g may be precisely determined using standard material deposition methods familiar in semiconductor processing (eg silicon dioxide deposition using PECVD). Photolithography used to define the window typically has a resolution of less than 1 micron.

Calibration requires the absolute value of the propagation constant of the modal field of the sensing waveguide to be determined prior to the introduction of a stimulus of interest. Provided that the refractive index of the capping layer is known, it is possible to perform calibration as follows.

With reference to FIG. 4, the measured difference Δ in output phase position of the two parallel parts of the modal field φₗ and φᵣ carried in the path of interaction of dual length is formulated as follows:
Δ=(β_{c}−βₛ)ΔL=ΔβΔL (1)
(where β_{c} is the propagation constant of the part of the modal field of the sensing waveguide beneath the capping layer and βₛ is the propagation constant of the part of the modal field of the sensing waveguide in the window.

Provided that the capping layer is sufficiently thick, the difference in the propagation constants (Δβ) depends only on the difference in refractive index between the medium in the window and the capping layer. The former may be air for example (whose refractive index is known to be approximately unity).

Using two orthogonal polarisations (TE and TM), two different values for Δ may be measured (Δ_{TE} and Δ_{TM}) . Equation 1 may be solved numerically for values of the refractive index and the thickness of the sensing waveguide that provide Δβ_{TE} and Δβ_{TM} corresponding to Δ_{TE} and Δ_{TM}. Plots of Δβ_{TE} and Δβ_{TM} versus thickness and refractive index cross each other and have a common value at a unique pair of parameters (thickness and refractive index) for the sensing waveguide. The absolute values for the propagation constants can be obtained by methods known to those skilled in the art.

FIG. 5 illustrates in exposed plan view an embodiment of the integrated optical waveguide interferometer of the invention. It is largely the same as that described above with reference to FIG. 1 but the absorbent sensing layer 4f has been replaced with a capping layer to expose the surface of the silicon oxynitride layer 4e acting as the sensing waveguide. The sensing waveguide mode is carried within a path of interaction of variable optical length provided by a gradient X. This permits fine details of the stepwise change in phase between the paths Lₗ and Lᵣ to be measured.

FIG. 6 illustrates an embodiment of an integrated optical waveguide interferometer of the invention. It is largely the same as that described above with reference to FIG. 1 but without the absorbent sensing layer 4f. The silicon oxynitride layer 4e (the sensing waveguide) is of dual thickness T₁ and T₂ to give a path of interaction of dual optical length as described below.

FIG. 7 illustrates an embodiment of an integrated optical waveguide interferometer of the invention. It is largely the same as that described above with reference to FIG. 1 but without the absorbent sensing layer 4f. The silicon oxynitride layer 4e (the sensing waveguide) is of dual composition (ie dual intrinsic refractive index RI¹ and RI²) to give a path of interaction of dual optical length as described below.

With reference to FIGS. 6 and 7, the optical path length (L′) is related to the geometrical path length (L) by
L′=λL/n
(where λ is the wavelength of the excitation radiation and n is the refractive index of the path of interaction)

Any variation in L′ can be used to determine the absolute phase condition. Variations in L have been described with reference to FIGS. 2 and 5. A sensing waveguide with known variation in refractive index (either dimensional—see FIG. 6 or intrinsic—see FIG. 7) may be used analogously.

1. An integrated optical waveguide interferometer capable of detecting the amount of or changes in a stimulus of interest comprising:
a sensing waveguide capable of exhibiting a measurable response to a change in a localised environment caused by the introduction of or changes in the stimulus of interest, said sensing waveguide having a path of interaction of variable optical length.

2. An integrated optical waveguide interferometer as claimed in claim 1 further including:
one or more sensing layers capable of inducing in the sensing waveguide a measurable response to a change in the localised environment caused by the introduction of or changes in the stimulus of interest.

3. An integrated optical waveguide interferometer as claimed in claim 2 further comprising:
an inactive waveguide in which the sensing layer is substantially incapable of inducing a measurable response to a change in the localised environment caused by the introduction of or changes in the stimulus of interest.

4. An integrated optical waveguide interferometer as claimed in claim 1 wherein the variation in optical length of the path of interaction is sufficient to ensure a variation in phase change caused by the introduction of or changes in the stimulus of interest of <2π.

5. An integrated optical waveguide interferometer as claimed in claim 1 wherein the path of interaction is stepped.

6. An integrated optical waveguide interferometer as claimed in claim 1 wherein the path of interaction is of dual optical length.

7. An integrated optical waveguide interferometer as claimed in claim 6 wherein the difference in dual optical length is sufficient to ensure a difference in phase change caused by the introduction of or changes in the stimulus of interest of <2π.

8. An integrated optical waveguide interferometer as claimed in claim 1 wherein the variation in optical length of the path of interaction is provided by a variation in its geometrical length.

9. An integrated optical waveguide interferometer as claimed in claim 8 wherein the variation in geometrical length is sufficient to ensure a variation in phase change caused by the introduction of or changes in the stimulus of interest of <2π.

10. An integrated optical waveguide interferometer as claimed in claim 8 wherein the geometrical length of the path of interaction is stepped.

11. An integrated optical waveguide interferometer as claimed in claim 8 wherein the path of interaction is of dual geometrical length.

12. An integrated optical waveguide interferometer as claimed in claim 11 wherein the difference in dual geometrical length is sufficient to ensure a difference in phase change caused by the introduction of or changes in the stimulus of interest of <2π.

13. An integrated optical waveguide interferometer as claimed in claim 8 wherein the variation in the geometrical length of the path of interaction is continuous.

14. An integrated optical waveguide interferometer as claimed in claim 13 wherein the path of interaction has a gradient.

15. An integrated optical waveguide interferometer as claimed in claim 1 wherein the variable optical length of the path of interaction is provided by a variation in its refractive index.

16. An integrated optical waveguide interferometer as claimed in claim 15 wherein the refractive index is varied intrinsically by varying the composition of the material of the sensing waveguide.

17. An integrated optical waveguide interferometer as claimed in claim 16 wherein the sensing waveguide is composed of two or more discrete portions of material of differing composition.

18. An integrated optical waveguide interferometer as claimed in claim 16 wherein the sensing waveguide is of dual composition.

19. An integrated optical waveguide interferometer as claimed in claim 15 wherein the refractive index is varied dimensionally.

20. An integrated optical waveguide interferometer as claimed in claim 19 wherein the refractive index is varied dimensionally by varying the thickness of the sensing waveguide.

21. An integrated optical waveguide interferometer as claimed in claim 19 wherein the sensing waveguide is of dual thickness.

22. An integrated optical waveguide interferometer as claimed in claim 1 further comprising a capping layer adapted to define the path of interaction of variable optical length.

23. An integrated optical waveguide interferometer as claimed in claim 22 wherein the capping layer incorporates a window which bounds the localised environment.

24. An integrated optical waveguide interferometer as claimed in claim 23 wherein the window bounds a medium so that the capping layer defines a path of interaction of at least dual optical length in which a first part of a modal field interacts with the medium in the window and a second part of the modal field interacts with the medium of the capping layer.

25. A process for determining the absolute status of an integrated optical waveguide interferometer, said process comprising:
(A) providing an integrated optical waveguide interferometer that includes a sensing waveguide capable of exhibiting a measurable response to a change in a localised environment caused by the introduction of or changes in a stimulus of interest, said sensing waveguide having a path of interaction of variable optical length;
(B) irradiating the integrated optical waveguide interferometer with electromagnetic radiation;
(C) introducing to the localised environment the stimulus of interest;
(D) measuring the variation in phase shift of the modal field interacting with the path of interaction; and
(E) calculating from the variation in phase shift the absolute status of the integrated optical waveguide interferometer.

26. A process as claimed in claim 25 wherein the variation in phase shift caused by the introduction of or changes in a stimulus of interest is <2π.

27. A process as claimed in claim 25 wherein the path of interaction is of dual optical length.

28. A process as claimed in claim 27 wherein the difference in phase shift caused by the introduction of or changes in a stimulus of interest is <2π.

29. A process as claimed in claim 25 further comprising:
(F) relating the absolute status to the amount of or changes in the chemical stimulus of interest.

30. A method for determining the absolute calibration status of an integrated optical waveguide interferometer, said method comprising:
(A) providing the integrated optical waveguide interferometer that includes a sensing waveguide capable of exhibiting a measurable response to a change in a localised environment caused by the introduction of or changes in a stimulus of interest, said sensing waveguide having a path of interaction of variable optical length;
(B) irradiating the integrated optical waveguide interferometer with electromagnetic radiation;
(C) measuring the variation in phase position of the modal field interacting with the path of interaction; and
(D) calculating from the variation in phase position the absolute calibration status of the integrated optical waveguide interferometer.

31. A method as claimed in claim 30 wherein the path of interaction is of dual optical length and wherein step (C) includes measuring the difference in phase position of the first and second parts of the modal field interacting with the path of interaction of dual optical length respectively.

32. A method as claimed in claim 30 wherein steps (A) to (C) are performed at start-up.
